(19) United States
(12) Patent Application Publication
(10) Pub. No.: US 2015/0310096 A1
(43) Pub. Date: Oct. 29, 2015

(54) COMPARING DOCUMENT CONTENTS USING A CONSTRUCTED TOPIC MODEL

(71) Applicant: International Business Machines Corporation, Armonk, NY (US)

(72) Inventors: Shenghua Bao, San Jose, CA (US); Hong Lei Guo, Beijing (CN); Zhi Li Guo, Beijing (CN); Davide Pasetto, Bedford Hills, NY (US); Wei Hong Qian, Beijing (CN); Zhong Su, Beijing (CN)

(21) Appl. No.: 14/695,688

(22) Filed: Apr. 24, 2015

(30) Foreign Application Priority Data
Apr. 29, 2014 (CN) 201410177307.9

(51) Int. Cl. G06F 17/30

(52) U.S. Cl. CPC G06F 17/30684; G06F 17/30011; G06F 17/30734

(57) ABSTRACT

Comparing document contents is provided. An ontological concept is extracted from a text snippet of a corpus document. One or more feature vectors are constructed that include associative information that describes an ontology that includes the focused concept. A topic model is trained using the one or more feature vectors. First and second topic sets are respectively extracted from first and second documents using the topic model. One or more topics from the first topic set are matched, using the topic model, with one or more topics from the second topic set to construct a matched topic set. Semantic analyses are respectively performed on first and second text snippet sets, wherein the first and second text snippet sets are chosen based, at least in part, on the matched topic set. Text snippets are matched based, at least in part, on the first and second semantic analyses.

### BACKGROUND OF THE INVENTION

The present invention relates to the analysis of document contents, and more specifically, to the construction of a topic model and the comparison of document contents by using the constructed topic model.

In the field of computer information processing, many applications and tools analyze and compare document contents. For example, a search engine can perform a preliminary semantic analysis on document contents so as to determine the correlation between the document and the searched keyword. Some search engines measure the correlation between a document and a given keyword. Some of these search engines, as well as others, have algorithm(s) that measure the correlation of two documents on the whole. There are also some version management tools, which can trace and record the change of the document contents in different versions by comparing the documents of different versions. Version management tools, however, merely compare the documents literally and do not extract the semantic information.

### SUMMARY

According to one embodiment of the present disclosure, a method for comparing document contents is provided. The method includes extracting, by one or more computer processors, a focused concept from a text snippet of a corpus document; constructing, by one or more computer processors, one or more feature vectors for the focused concept, wherein each feature vector includes associative information that describes an ontology that includes the focused concept; training a topic model, by one or more computer processors, based, at least in part, on at least one of the one or more feature vectors; responsive to extracting, by one or more computer processors, a first topic set from a first document and a second topic set from a second document, matching, by one or more computer processors, one or more topics from the first topic set with one or more topics from the second topic set, using the topic model, to construct a matched topic set; and responsive to performing, by one or more computer processors, a first semantic analysis on a first text snippet set of the first document and a second semantic analysis on a second text snippet set of the second document, wherein the first and the second text snippet sets are chosen based, at least in part, on the matched topic set, matching, by one or more computer processors, one or more text snippets of the first text snippet set with one or more text snippets of the second text snippet set based, at least in part, on the first and the second semantic analyses.

According to another embodiment of the present disclosure, a computer program product for comparing document contents is provided. The computer program product comprises a computer readable storage medium and program instructions stored on the computer readable storage medium. The program instructions include program instructions to extract a focused concept from a text snippet of a corpus document; program instructions to construct one or more feature vectors for the focused concept, wherein each feature vector includes associative information that describes an ontology that includes the focused concept; program instructions to train a topic model based, at least in part, on at least one of the one or more feature vectors; program instructions to, responsive to program instructions to extract a first topic set from a first document and a second topic set from a second document, match, using the topic model, one or more topics from the first topic set with one or more topics from the second topic set to construct a matched topic set; and program instructions to, responsive to program instructions to perform a first semantic analysis on a first text snippet set of the first document and a second semantic analysis on a second text snippet set of the second document, wherein the first and the second text snippet sets are chosen based, at least in part, on the matched topic set, match one or more text snippets of the first text snippet set with one or more text snippets of the second text snippet set based, at least in part, on the first and the second semantic analyses.

According to another embodiment of the present disclosure, a computer system for comparing document contents is provided. The computer system includes one or more computer processors, one or more computer readable storage media, and program instructions stored on the computer readable storage media for execution by at least one of the one or more processors. The program instructions include program instructions to extract a focused concept from a text snippet of a corpus document; program instructions to construct one or more feature vectors for the focused concept, wherein each feature vector includes associative information that describes an ontology that includes the focused concept; program instructions to train a topic model based, at least in part, on at least one of the one or more feature vectors; program instructions to, responsive to program instructions to extract a first topic set from a first document and a second topic set from a second document, match, using the topic model, one or more topics from the first topic set with one or more topics from the second topic set to construct a matched topic set; and program instructions to, responsive to program instructions to perform a first semantic analysis on a first text snippet set of the first document and a second semantic analysis on a second text snippet set of the second document, wherein the first and the second text snippet sets are chosen based, at least in part, on the matched topic set, match one or more text snippets of the first text snippet set with one or more text snippets of the second text snippet set based, at least in part, on the first and the second semantic analyses.

### BRIEF DESCRIPTION OF THE DRAWINGS

FIG. 1 is a block diagram of a computing device executing operations for comparing document contents, in accordance with an embodiment of the present disclosure;

FIG. 2 is a flowchart depicting operations for training a topic model, in accordance with an embodiment of the present disclosure;

FIG. 3 is a flowchart depicting operations for comparing document contents, in accordance with an embodiment of the present disclosure;

FIG. 4 is a flowchart depicting operations for obtaining the first topic set, in accordance with an embodiment of the present disclosure;

FIG. 5A is a diagram that depicts one example of aligned topics from a first document and a second document, in accordance with an embodiment of the present disclosure;

FIG. 5B is a diagram that depicts one example of aligned text snippets, wherein the text snippets relate to the topics depicted in FIG. 5A, in accordance with an embodiment of the present disclosure;

FIG. 6 is a functional block diagram depicting an apparatus for training a topic model, in accordance with an embodiment of the present disclosure; and

FIG. 7 is a functional block diagram depicting an apparatus for comparing document contents, in accordance with an embodiment of the present disclosure.

### DETAILED DESCRIPTION

Various embodiments of the present invention recognize a need to semantically compare two or more documents having similar contents, wherein the comparison identifies and/or differentiates semantically similar and semantically unrelated sections. For instance, in one example, there are two documents that respectively describe the functional features of two similar operating systems. Users desire to analyze and compare these two documents to know which functional features are shared between these two operating systems. In another example, two documents describe the legal regulations regarding battery usage and disposal in two different regions. Users desire to determine, by comparing these two documents, the difference(s) in the battery disposal regulations of the two regions. In the above two examples, although two documents describe similar contents, the way of description may have large differences. For example, two documents may have totally different document structures and describe the same topic from different views and aspects, or they may use different terms to express the same concept. This brings difficulty to document analysis and comparison.

Some search engines measure the correlation between a document and a given keyword. Some of these search engines, as well as others, have algorithm(s) that measure the correlation of two documents on the whole. Such search engines, however, cannot semantically analyze and align the sections of different documents. Version management tools merely compare the documents literally, and cannot extract the semantic information. Facing two documents with different document structures and different terms, such version management tools cannot compare and analyze the semantic basis. Various embodiments of the present invention provide a method and/or apparatus for analyzing and comparing semantics between two or more documents.

Embodiments of the present disclosure will now be described in more detail with reference to the accompanying drawings. The present disclosure can be implemented in various manners, and thus should not be construed to be limited to the embodiments disclosed herein. On the contrary, those embodiments are provided for the thorough and complete understanding of the present disclosure and conveying the scope of the present disclosure to those skilled in the art.

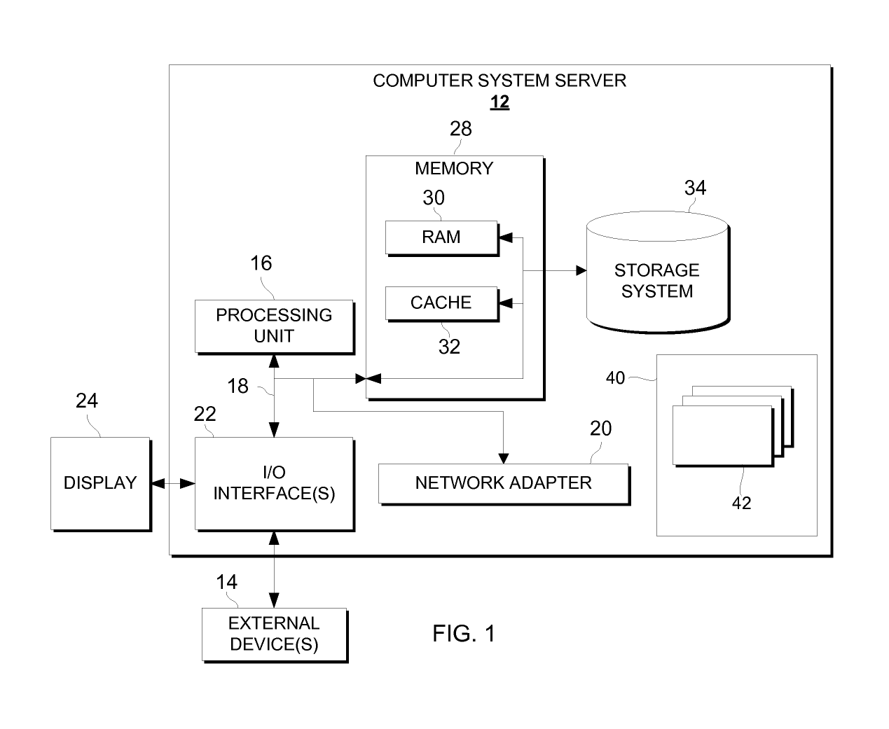

Referring now to FIG. 1, in which an exemplary computer system/server 12 is shown. Computer system/server 12 is illustrative and is not intended to suggest any limitation as to the scope of use or functionality of embodiments of the present disclosure described herein.

As shown in FIG. 1, computer system/server 12 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, such architectures include an Industry Standard Architecture (ISA) bus, a Micro Channel Architecture (MCA) bus, an Enhanced ISA (EISA) bus, a Video Electronics Standards Association (VESA) local bus, and a Peripheral Component Interconnect (PCI) bus.

Computer system/server 12 typically includes a variety of computer readable media. Such media may be any available media that is accessible by computer system/server 12, and it includes both volatile and non-volatile media and removable and non-removable media.

System memory 28 can include computer readable media in the form of volatile memory, such as random access memory (RAM) 30 and/or cache memory 32. Computer system/server 12 may further include other removable/non-removable, volatile/non-volatile computer system storage media. By way of example, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the present disclosure.

Program/utility 40, having a set (e.g., at least one) of program modules 42, as well as an operating system, one or more application programs, other program modules, and program data may be stored in memory 28, by way of example. Each of the operating system, one or more application programs, other program modules, and program data or some combination thereof, may include an implementation of a networking environment. Program modules 42 generally carry out the functions and/or methodologies of embodiments of the present disclosure as described herein.

Computer system/server 12 may also communicate with one or more external devices 14 such as a keyboard, a pointing device, and/or display 24, etc.; one or more devices that enable a user to interact with computer system/server 12; and/or any devices (e.g., a network card, a modem, etc.) that enable computer system/server 12 to communicate with one or more other computing devices. Such communication can occur via Input/Output (I/O) interfaces 22. Computer system/server 12 can also communicate with one or more networks such as a local area network (LAN), a general wide area network (WAN), and/or a public network (e.g., the Internet) via network adapter 20. As depicted in FIG. 1, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

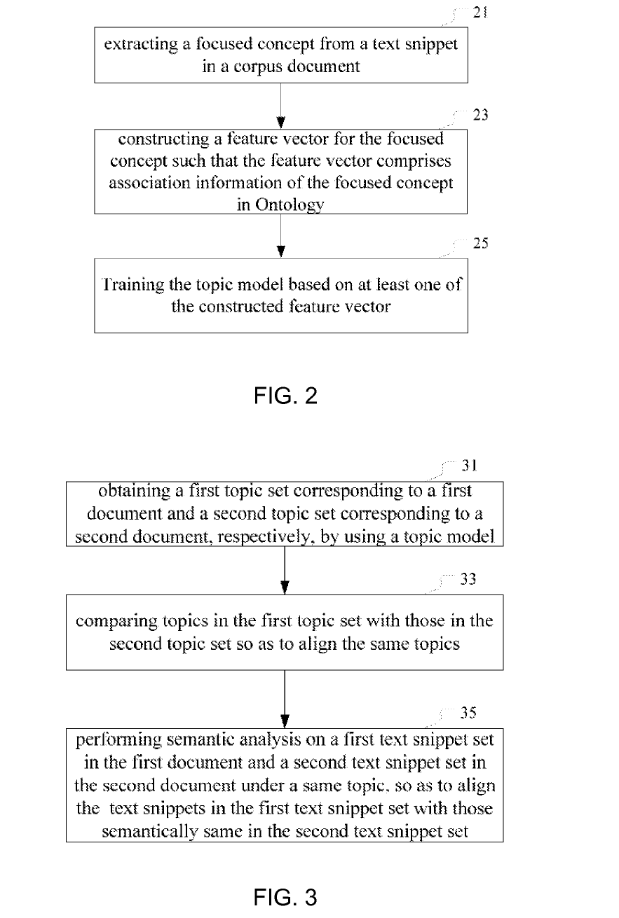

Next, the methods and steps for training a topic model and comparing document contents according to examples of the invention will be described by referring to FIGS. 2-4. In these examples, a topic model is trained based, at least in part, on ontological information relating to associations between various focused concepts in one or more documents (i.e., associative information that describes an ontology that includes the focused concept), such that the topic model can reflect the deep semantic information of the concepts and the association between the concepts. Furthermore, based on the topic model thus trained, it is possible to identify topics included in various documents and align (i.e., match) the topics on the topic level. Semantic analysis may then be performed on text snippets of the topics in order to align the text snippets (i.e., match semantically similar text snippets).

A topic model is a method for modeling latent topics in text, and is generally used in semantic mining and semantic analysis. In general, a topic is described with a particular word frequency distribution. More particularly, it can be deemed that each word in a document is obtained by selecting a certain topic with certain probability and then selecting from the topic the word with particular probability. This process may be expressed as: P (word|document)=Σp (word|topic)*p(topic|document).

Alternatively, the above formula may be expressed as the form of matrix multiplication:

Cᵢⱼ=φᵢₖ×θₖⱼ Equation 1

Wherein Cᵢⱼ stands for the probability of word i in document j, φᵢₖ stands for the probability of word i in topic k, and θₖⱼ stands for the probability of topic k in document j. As each document may be expressed as a set of words, Cᵢⱼ may be obtained by dividing the number of words i by the total number of words in document j. That is, for a document in the corpus, the left-side matrix Cᵢⱼ may be known by simple calculation, while the two matrices at right side are unknown. Thus, it is possible to use a large number of documents and the corresponding matrices Cᵢⱼ, after exposure to a series of training documents, to deduce the right side “word-topic” matrix φᵢₖ and the “topic-document” matrix θₖⱼ.

In order to deduce the above two matrices, many training and deduction methods can be used, such as the pLSA (probabilistic Latent Semantic Analysis) method and LDA (Latent Dirichlet Allocation) method. The pLSA method iteratively calculates the two matrices by using the Expectation Maximization algorithm, and finally gets the approximately underground φᵢₖ and θₖⱼ. The LDA method assumes that documents and topics follow Dirichlet distribution, and topics and words follow the multinomial distribution. The LDA method deduces the above two matrices with Gibbs sampling.

Thus, it is possible to obtain the “word-topic” matrix φᵢₖ and the “topic-document” matrix θₖⱼ, in the topic model training by inputting the probabilities of words in documents without manually labeling topics. As the matrix φᵢₖ shows the probability of word i in topic k, the topic may be expressed as a set of word distributions using the matrix.

The above methods, however, do not consider the semantic association between words, and therefore, the obtained topic model generally does not reflect deep semantic information. Thus, in at least some examples of the present disclosure, the training of a topic model is performed in conjunction with associating ontological information with various focused concepts in one or more documents. In particular, FIG. 2 shows a flow chart of a method for training a topic model according to one example of the invention. As shown in FIG. 2, the method for training a topic model in the example includes the following steps: step 21 of extracting a focused concept from a text snippet in a corpus document; step 23 of constructing a feature vector for the focused concept such that the feature vector includes associative information that describes the ontology that includes the focused concept; and step 25 of training the topic model based on at least one of the constructed feature vectors. Next, the implementing process of the steps will be described in detail.

In step 21, the process is to extract a focused concept from a text snippet in a corpus document. It can be understood that the corpus may be a set of numerous documents used for model training. These documents may be related to different fields and different topics. For any document, it can be divided into some text snippets. A text snippet may be a paragraph or sentence naturally formed in documents, or in another form, a text snippet may be a paragraph of words divided artificially. In a typical example, the text snippet is a sentence in documents.

For the above mentioned text snippet, in step 21, the process may be extracting a focused concept therefrom by using linguistic analysis. It is deemed herein that a focused concept is an abstract expression for an entity described in the text snippet. In linguistics, a focused concept is generally expressed in limited forms, such as the key noun in a sentence.

The existing computer linguistic analysis is able to distinguish the constituents in a sentence and determine the modification relationship between words. Therefore, by using linguistic analysis, it is possible to extract at least one focused concept from a text snippet. Examples of text snippets are shown below.

“No person shall sell or offer for sell alkaline manganese batteries having sizes and shapes resembling buttons or coins which have a mercury content of more than 25 mg of mercury per battery.” (text snippet 1)

“A manufacturer shall not sell, distribute, or offer for sale an alkaline manganese battery, except an alkaline manganese button cell, that contains added mercury, unless the commissioner grants an exemption.” (text snippet 2)

“The battery must be clearly identifiable as to the type of the battery and the name of the manufacturer on battery package.” (text snippet 3)

By linguistic analysis, it is possible to extract the words “alkaline manganese battery” from the above text snippets 1 and 2 as the focused concept, and extract “battery package” from the text snippet 3 as the focused concept.

Then, in step 23, the process is to construct a feature vector for the focused concept such that the feature vector includes associative information that describes the ontology that includes the focused concept. In this step, ontological concepts enable the construction of the feature vector

As known by those skilled in the art, Ontology is originally a philosophical concept used to study the nature of existence of objective things. But in recent years, with the development of information technology, this theory has been applied to the field of computer information processing, and it has played a big role in artificial intelligence, computer language, and database theory.

In the field of information processing, Ontology may be used to explain various concepts and the relationship thereof in a certain domain. In particular, the basic element of Ontology is a term or a concept, and terms or concepts with some common attributes may constitute a category and sub-category. Ontology also describes the relationship between categories and concepts. In a domain, the sum of such concepts and the relationship thereof may be referred to as the ontology of the domain. Formally, the ontology of a domain may be expressed as a glossary describing the concepts in the domain, wherein the glossary may be organized into a tree structure to show the relationship among the concepts. Such a glossary with a tree structure may also be referred to as an ontology tree.

Based on the above described systematic knowledge of Ontology, deep semantic analysis and information mining may be conducted for the focused concept extracted in step 21. In particular, in step 23, the process is to map the focused concept into an ontology tree of a domain, and then, based on the information in the ontology tree, to obtain the associative information that describes the ontology that includes the focused concept.

In one example, the above associative information includes domain information of the focused concept. As described above, Ontology organizes various concepts according to domains, and thus forms ontology trees. Thus, when the focused concept is mapped into an ontology tree, the domain corresponding to the ontology tree may be considered as the domain of the focused concept. On this basis, it is also possible to determine a more generic domain of the above mentioned domain. For example, if the focused concept “alkaline manganese battery” extracted from the text snippet 1 is mapped into an ontology tree organized for the battery domain, it can be deemed that the focused concept belongs to the battery domain. Furthermore, it is possible to determine the more generic domain of this domain, such as an electronics domain.

In one example, the above associative information includes categorical information relating to the focused concept. In particular, the above categorical information may include one or more of the following items: a more generic concept, a more specific concept, and an equivalent concept (if any) of the above focused concept in the corresponding ontology tree. This can be obtained by analyzing the corresponding ontology tree. For example, for the focused concept “alkaline manganese battery” extracted from the text snippet 1, it can be known, based, at least in part, on the ontology tree of the corresponding battery domain that, the more generic concepts thereof include chemical battery, button battery, etc., and more specific concepts thereof, such as alkaline manganese button battery, etc.

In another example, the above associative information includes information relating to the attributes of an entity corresponding to the above focused concept. In some cases, Ontology semantically classifies various concepts according to the attributes of the entities corresponding to the concepts. According to different attributes, a concept may be classified into different categories. In this case, it is possible to use the semantic classification information to obtain information relating to the attributes of the corresponding entity. For example, for the above focused concept “alkaline manganese battery”, the attributes of the corresponding entity may include size, weight, shape, constituent, etc. In one example, such information relating to attributes may also be extracted from text snippets. For instance, in text snippet 1, “size” and “shape” are used to define the focused concept “alkaline manganese battery”, and therefore, such definitions may be considered to be information relating to the attributes of “alkaline manganese battery”.

Based on the associative information described above, those skilled in the art may obtain more associative information concerning the extracted focused concept based on knowledge of Ontology. In addition, additional information concerning the focused concept may be obtained to serve as feature elements for use in constructing the feature vector.

If the extracted focused concept is a compound word, for example, the internal word information of the compound word may be obtained and be included in the feature vector. For example, the above mentioned focused concept “alkaline manganese battery” is a compound word, and may be divided into internal word elements “alkaline,” “manganese,” and “battery”. Such internal word information may serve as feature elements to be included in the feature vector.

In one example, it is possible to obtain statistical collocation information concerning the focused concept as a feature element of the feature vector. It can be understood that the information concerning word collocation may be obtained by learning (i.e., analyzing) a large number of documents in advance. Alternatively, while scanning document snippets according to the steps of the examples of the invention, statistical analysis may be conducted on the word collocation information, thus forming the statistical information concerning word collocation. By using such information, it is possible to directly obtain the statistical collocation information concerning the focused concept. Thus, the obtained statistical collocation information concerning the focused concept may indicate, for example, which words the focused concept often collocates together with. For instance, in one example, the above statistical collocation information includes other concepts that appear concurrently with the above focused concept in the same document snippet with a relatively high probability (for example, higher than a predefined first threshold). Optionally, the above statistical information may also include concepts that are “mutually exclusive” with the above focused concept, that is, other concepts that appear concurrently with the above focused concept with a relatively low probability (for example, lower than a predefined second threshold). For example, for the above focused concept “alkaline manganese battery”, it can be determined by using the statistical information concerning word collocation information that, the concepts that often appear concurrently with it are “mercury”, “content”, etc., and the concepts that are mutually exclusive with it are “nickel-cadmium battery”, “carbon-zinc battery”, etc. This information may serve as the statistical collocation information of the focused concept “alkaline manganese battery”.

In one embodiment, it is also possible to obtain contextual information relating to the extracted focused concept in the text snippet as a feature element of the feature vector. In one example, the contextual information includes other concepts close to (for example, with a distance smaller than a threshold) the focused concept in the text snippet. In another example, the contextual information includes the key verb or verb phrase in the text snippet. In yet another example, the context information further includes the key noun or noun phrase in the text snippet. For example, for the focused concept “alkaline manganese battery” in text snippet 1, it is possible to extract from text snippet 1 the verbs “sale” and “offer to sale” as the contextual information.

By using many kinds of information, as described above, it is possible to construct a feature vector for the focused concept of the text snippet. Compared with other methods, the feature vector constructed in step 23 includes information on a deeper level. For example, when scanning text snippet 1, other method of training topic models merely extracts words from it, such as “no, person, shall, sell, offer, sale . . . ”, and uses the word frequencies of these words to construct the matrix Cᵢⱼ on the left side of Equation 1. However, according to step 23 as described in combination with FIG. 2, on the basis of extracting the focused concept A (in the case of text snippet 1, A=“alkaline manganese battery”), a feature vector V may be constructed for the focused concept A as follows:

V=(A, the internal word information of A, the domain of A, the super domain of A, the super-category concept of A, the sub-category concept of A, the attribute feature of A, the collocation statistic information of A, the key phrase in the context of A).

Many kinds of information have been described hereinbefore, in conjunction with examples, to illustrate how to construct a feature vector. One form of expression of the feature vector, V, has also been described. Persons of ordinary skill in the art, however, will understand that one or more of the kinds of information described above can be used to construct the feature vector. Furthermore, those skilled in the art can make further expansion, modification, or combination based on the information described above, and thus obtain more or additional information for use in constructing the feature vector. The expression form, element number, and element type of the feature vector are not limited to the above examples. The constructed feature vector reflects multi-dimensional information of the focused concept and more comprehensively reflects the character of the entity identified in the corresponding text snippet.

What is described above is step 21 of extracting a focused concept from a text snippet, and step 23 of constructing a feature vector for the focused concept. By repeatedly carrying out steps 21 and 23, it is possible to extract a plurality of focused concepts from a plurality of text snippets of the corpus documents and construct a plurality of respective feature vectors for the plurality of focused concepts. On this basis, step 25 may be performed to train a topic model based on at least one of the constructed feature vectors, and more typically, based on a set of a plurality of feature vectors. The process of model training may employ many methods.

In one embodiment, the topic model training is conducted by way of clustering. In particular, the obtained plurality of feature vectors are clustered according to the distances among the vectors, such that the feature vectors with small distance (for example, smaller than a distance threshold) are clustered together. The above clustering process may be realized by many clustering algorithms in the prior art, thus obtaining many clusters. It can be deemed that each cluster obtained by the above process corresponds to a topic.

In one example, a topic may be expressed as the center of a corresponding cluster. As a cluster consists of a plurality of feature vectors, it is possible to map the plurality of feature vectors into a vector space of corresponding dimensions, determine the center “position” of the plurality of feature vectors in the vector space by various methods, and use the vector corresponding to the center “position” to represent the topic that corresponds with the cluster. Therefore, the topic may be expressed in the form of a vector having the same dimensions as the feature vector(s). This vector is also referred to as a topic vector. It can be understood that, in other examples, other methods may be used to calculate or express the topic corresponding to the cluster.

In one embodiment, the topic model training is conducted by way of matrix calculation. In particular, at least one obtained feature vector may be used to construct a matrix, which shows the distribution of various elements of the feature vector in various documents. This matrix is considered to be the data source for training, whose role is similar to matrix Cᵢⱼ in Equation (1). By using various method of deduction, such as pLSA and LDA methods, matrix φᵢₖ may be obtained in manner that is similar to the manner in which the topic matrix is obtained. Through the topic matrix, a topic may be likewise expressed in the form of a topic vector. This is consistent with the result of training using the clustering method.

Those skilled in the art may employ other ways to train the topic model based on the set of feature vectors.

As the feature vectors are constructed by considering the ontological information that relates to the focused concept, they reflect the essential features of the entities described by the focused concept(s). Therefore, topic models trained based on such feature vectors can better reflect the association(s) between the topics and the entities.

After a topic model is trained, the trained topic model may be used to compare document contents. FIG. 3 shows a flow chart of a method for comparing document contents according to one example of the invention. As shown in FIG. 3, the method for comparing document contents in the example includes the following steps: step 31 of respectively obtaining a first topic set corresponding to a first document and a second topic set corresponding to a second document by using a topic model, wherein the topic model is trained based on a feature vector constructed for a concept, and wherein the feature vector includes associative information relating to the ontological concept; step 33 of comparing topics in the first topic set with those in the second topic set so as to align and/or match the same topics and produce a matched topic set; and step 35 of performing semantic analyses on a first text snippet set in the first document and a second text snippet set in the second document under a same topic, so as to align and/or match the text snippets in the first text snippet set with those semantically similar text snippets in the second text snippet set. Implementation of the steps will be described in detail below.

In step 31, the process is to respectively obtain a first topic set corresponding to the first document and a second topic set corresponding to the second document using the topic model. It can be understood that the topic model is a model trained by the method of FIG. 2, wherein the basis of training is a plurality of feature vectors constructed for a plurality of concepts, and wherein each feature vector includes associative information relating to a corresponding ontological concept. Under such a trained topic model, each topic may be expressed as the distribution of element values of feature vectors. Now, in conjunction with the first document, the process of obtaining the topic set by using the topic model will be described.

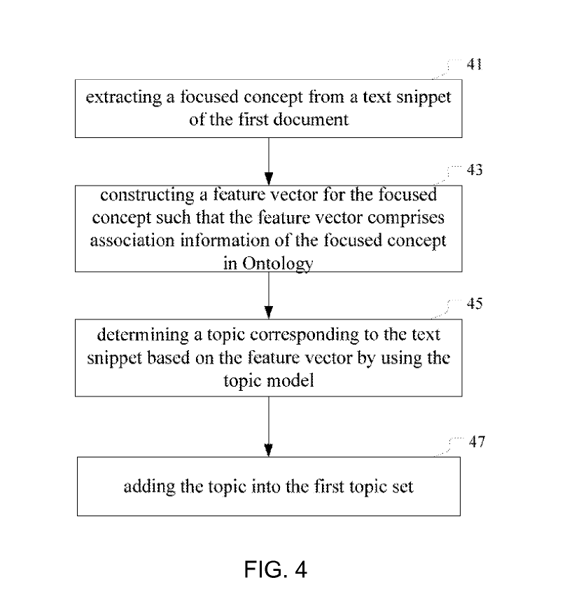

FIG. 4 shows the steps of obtaining the first topic set according to one example. It can be understood that, in order to facilitate the analysis, the first document can be divided into a plurality of text snippets. A text snippet may be a paragraph or sentence naturally formed in documents, or may be a paragraph of words divided artificially or in other form. In one example, the text snippet is a sentence in documents.

On this basis, a focused concept is extracted from a text snippet of the first document in step 41. The extraction of the focused concept may be realized by using the existing linguistic analysis. The detailed implementing process of this step is similar to step 21 of FIG. 2.

In step 43, a feature vector for the focused concept is constructed such that the feature vector includes associative information that describes the ontology that includes the focused concept. In particular, and in a similar manner as step 23, the process may be to first map the focused concept into an ontology tree of a domain, and then, based on the information in the ontology tree, to obtain the associative information that describes the ontology that includes the focused concept.

In one example, the associative information described above includes domain information of the above focused concept.

In another example, the associative information described above includes information relating to the focused concept. In particular, the categorical information may include one or more of the following items: a more generic concept, a more specific concept, and an equivalent concept (if any) of the above focused concept in the corresponding ontology tree.

In yet another example, the associative information described above includes information relating to attributes of an entity corresponding to the above focused concept.

Optionally, the internal word information of the focused concept may be obtained and included in the feature vector.

In one example, it is possible to obtain statistical collocation information concerning the focused concept as a vector element of the feature vector.

In another example, it is also possible to obtain the contextual information of the extracted focused concept in the text snippet as a vector element of the feature vector.

For the obtaining process and detailed examples of the above information, reference can be made to the description of step 23 of FIG. 2. Those skilled in the art may select one or more kinds of the information described above to construct the feature vector. Furthermore, those skilled in the art can make further expansion, modification or combination based on the information described above, and thus obtain additional information for use in constructing the feature vector. It should be understood, however, that the feature vector constructed in step 43 is used to determine the topic of the text snippet based on the topic model, and therefore, this feature vector should be consistent with the feature vectors serving as the basis for topic model training in terms of their vector dimensions and elements. That is, if a particular method is used to construct the feature vector when training the topic model, the same method should be used to construct the feature vector when determining the topics by using the topic model.

After constructing the feature vector in step 45, the process is to determine a topic of the text snippet based on the feature vector using the topic model. It can be understood that, if the topic model has been trained and obtained, the topic of the text snippet can be directly determined by carrying out calculation(s), corresponding to the topic model, on the feature vector. In one example, the topic in the topic model is expressed in the form of a topic vector. In this case, the above feature vector may be compared with the topic vectors of various topics under the topic model, and the matched topic is determined as the topic corresponding to the text snippet. It can be understood that the topic vector and the feature vector have the same dimension. Therefore, by calculating and comparing the vector distance, the topic vector having the shortest distance with the constructed feature vector may be determined. The topic corresponding to the above topic vector is determined to be the matched topic, or in other words, the topic corresponding to the above text snippet.

In step 47, the above topic is added to the first topic set.

By repeatedly carrying out steps 41 to 47 on respective text snippets in the first document, the topics of the text snippets may be determined, thereby obtaining the first topic set corresponding to the first document.

The method for obtaining the topic set has been described above in conjunction with the first document. Persons of ordinary skill in the art will understand that the method is likewise applicable to the second document. By similarly carrying out steps 41 to 47 on respective text snippets in the second document, the second topic set corresponding to the second document may be obtained.

After respectively obtaining the topic sets of the first document and the second document in step 33, the process is to compare the topics in the first topic set with those in the second topic set so as to align and/or match the same topics and produce a matched topic set. It can be understood that each topic may have a corresponding topic mark or label. Once the topic of a particular text snippet is determined, it is possible to add the corresponding topic label to the text snippet. The first topic set includes the topic labels of respective text snippets in the first document, and the second topic set includes the topic labels of respective text snippets in the second document. By comparing these topic labels, it is possible to easily determine the same topics in the two topic sets and align and/or match the same topics to produce a matched topic set.

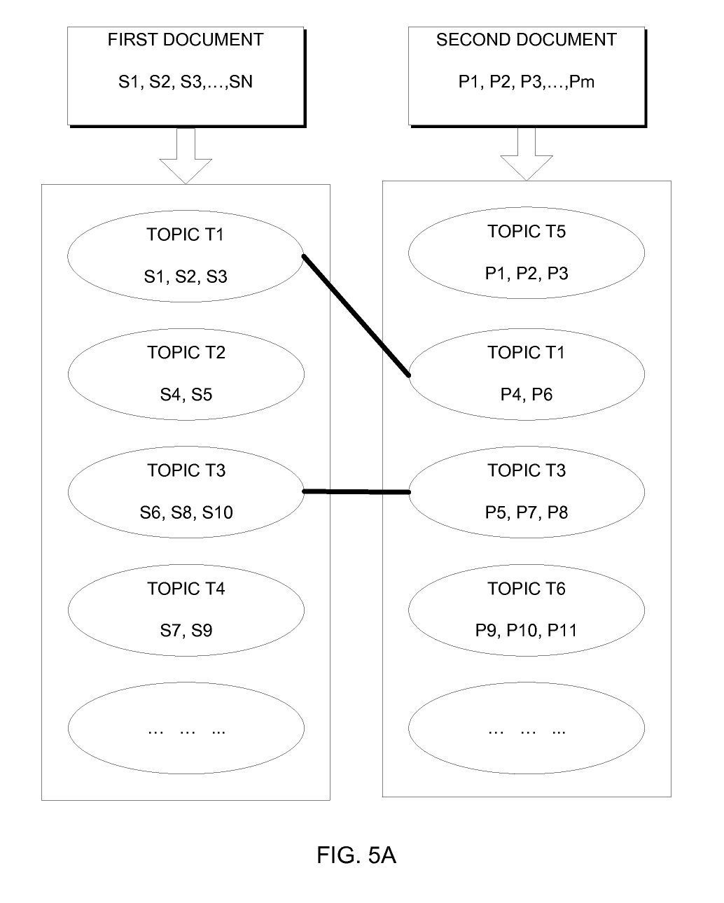

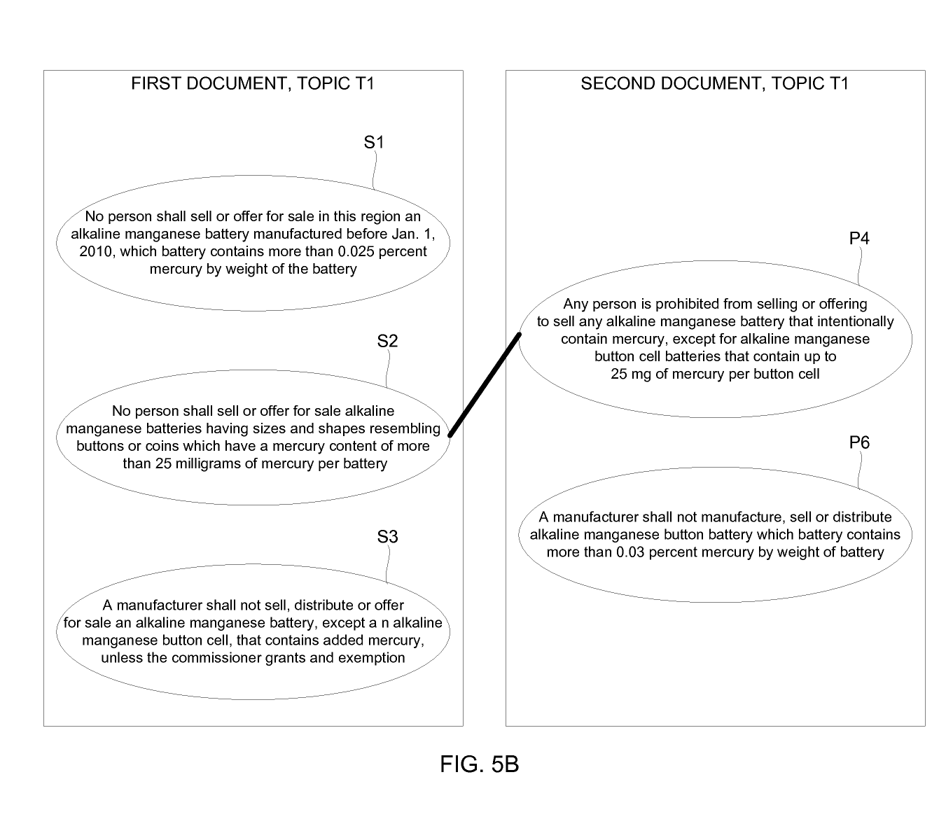

FIG. 5A shows one example of the alignment of the topics of the first document and the second document. In the example of FIG. 5A, the first document includes text snippets S1, S2, S3, . . . , Sn, and the second document includes text snippets P1, P2, P3, . . . , Pm. Using the topic model, it is determined that text snippets S1-S3 in the first document correspond to topic T1, S4 and S5 correspond to topic T2, S6, S8 and S10 correspond to topic T3, S7 and S9 correspond to topic T4, and so on. Therefore, the first topic set comprises topics T1, T2, T3, T4, etc. Similarly, suppose that text snippets P1-P3 in the second document correspond to topic T5, P4 and P6 to topic T1, P5, P7 and P8 to topic T3, P9-P11 to topic T6, and so on. By comparing the topic labels, it is easy to determine the same topics T1 and T3 in the two topic sets, and align the same topics and compare and match the relevant portions of the first and second documents. Therefore, the matched topic set includes topic T1 and T3.

In step 35, the process is to perform semantic analysis on a first text snippet set in the first document and a second text snippet set in the second document so as to align and/or match the text snippets in the first text snippet set with those that are semantically similar in the second text snippet set, wherein the first text snippet set and the second text snippet set relate to the same topic. It can be understood that, because of the correspondence between text snippets and topics, for similar topics in the first topic set and in the second topic set (i.e., topics in the matched topic set), it is easy to obtain the first text snippet set corresponding to the topic in the first document and the second text snippet set corresponding to the topic in the second document. In the example shown in FIG. 5A, the first topic set and the second topic set have the same topic T1 (i.e., the matched topic set includes topic T1). In the first document, the text snippets corresponding to topic T1 include S1-S3, which constitute the first text snippet set; in the second document, the text snippets corresponding to topic T1 include P4 and P6, which constitute the second text snippet set.

For the first text snippet set and the second text snippet set described above, semantic analysis and comparison detect the semantic difference between the text snippets. Many methods of semantic analysis may be employed to perform the above process. In one example, word level semantic analysis is employed to analyze the text snippets. In this process, words that appear in text snippets are considered. In another example, concept level comparison is employed on the text snippets, wherein the comparison includes comparison of entities, comparison of domain terms, and so on. In yet another example, ontologically similar concepts in the text snippets are considered so as to further determine the semantic similarities of the text snippets. By such semantic analyses, it is possible to obtain the semantically similar text snippets in the first text snippet set and in the second text snippet set, thus realizing the alignment of semantic snippets.

FIG. 5B shows one example of the alignment of the text snippets in the example of FIG. 5A. As described above, text snippets S1-S3 in the first document constitute the first text snippet set and text snippets P4 and P6 in the second document constitute the second text snippet set, wherein text snippets S1-S3, P4, and P6 relate to topic T1. FIG. 5B shows the contents of these text snippets in detail. It can be seen that, although these text snippets belong to the same topic, they still have semantic differences. It can be determined from semantic analysis that the text snippet S2 in the first document and the text snippet P4 in the second document have the same meaning, and therefore, in step 35, these two text snippets may be aligned (i.e., matched).

It can be seen from the above description that the method depicted in FIG. 3 uses the topic model to respectively obtain the topics of two documents and aligns and/or matches the same topics; then, the method uses semantic analysis to align and/or match the text snippets under the same topic, finally realizing the comparison of the contents in two documents. By using the above method, even if two documents have totally different document structures, use different terminology systems, and make description in different orders, it is still possible to compare the essential contents of the two documents.

The method of FIG. 3 is particularly applicable to the case that the first document and the second document respectively describe laws and regulations of a same domain in two regions. As laws and regulations generally make stipulations directed to entities, it is possible to obtain the ontological information of the various concepts within documents describing laws and regulations and then use a topic model based on the ontological information to realize the alignment of topics. The situation in which two documents describe the legal regulations regarding battery usage and disposal in two different regions is described herein. In this situation, users desire to determine, by comparing these two documents, the difference(s) in the battery disposal regulations in the two regions. Using the method described in the present disclosure, it is possible to effectively realize the alignment of topics and the alignment of text snippets such that users may find the corresponding regulations of the two regions and then determine the difference(s) between the regulations of the two regions.

Based on the concepts described herein, the present disclosure further provides an apparatus for training a topic model and an apparatus for comparing document contents.

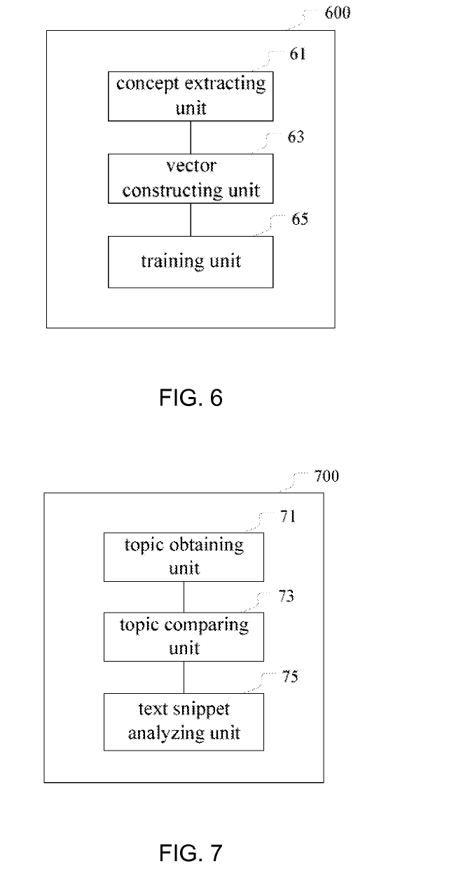

FIG. 6 shows a block diagram that depicts one example of an apparatus for training a topic model, in accordance with various aspects of the present disclosure. As shown in FIG. 6, the apparatus 600 for training a topic model includes: concept extracting unit 61, which configured to extract a focused concept from a text snippet in a corpus document; vector constructing unit 63, which configured to construct a feature vector for the focused concept such that the feature vector includes associative information that describes the ontology that includes the focused concept; and training unit 65, which is configured to train the topic model based on at least one of the constructed feature vectors.

In one embodiment, vector constructing unit 63 is configured to map the focused concept into an ontology tree of a certain domain, and obtain the associative information based, at least in part, on information in the ontology tree.

In another embodiment, the associative information includes categorical information relating to the focused concept, which includes one or more of the following items: a more generic concept, a more specific concept, and an equivalent concept of the above focused concept in its mapped ontology tree.

In yet another embodiment, the associative information includes one or more of the following items: domain information of the above focused concept, and attribute feature information of an entity corresponding to the above focused concept.

In one embodiment, vector constructing unit 63 is further configured to obtain at least one of the following items as a vector element of the feature vector: statistical collocation information concerning the focused concept, and contextual information of the focused concept in the text snippet.

In one embodiment, training unit 65 is configured to train the topic model using vector clustering manner and express a topic under the topic model as a topic vector.

FIG. 7 shows a block diagram that depicts one example of an apparatus for comparing document contents, in accordance with various aspect of the present disclosure. As shown in FIG. 7, apparatus 700 for comparing document contents includes: topic obtaining unit 71, which is configured to respectively obtain a first topic set corresponding to a first document and a second topic set corresponding to a second document using a topic model, wherein the topic model is trained based on a feature vector constructed for a concept, and wherein the feature vector includes associative information relating to the ontological concept; topic comparing unit 73, which is configured to compare topics in the first topic set with those in the second topic set so as to align and/or match the same topics; and text snippet analyzing unit 75, which is configured to perform semantic analysis on a first text snippet set in the first document and a second text snippet set in the second document under a same topic, so as to align and/or match the text snippets in the first text snippet set with those text snippets that are semantically similar in the second text snippet set.

In one embodiment, topic obtaining unit 71 includes: a concept extracting module (not shown), which is configured to extract a focused concept from a text snippet of the first document; a vector construction module (not shown), which configured to construct a feature vector for the focused concept such that the feature vector includes associative information that describes the ontology that includes the focused concept; a topic determining module (not shown), which is configured to determine a topic corresponding to the text snippet based on the feature vector by using the topic model; and a topic adding module (not shown), which is configured to add the topic into the first topic set.

In one embodiment, the associative information described above includes at least one of the following items: domain information of the above focused concept, categorical information of the focused concept, and information relating to attributes of an entity corresponding to the focused concept.

In one embodiment, the vector construction module described above is further configured to obtain at least one of the following items as a vector element of the feature vector: statistical collocation information concerning the focused concept and contextual information of the focused concept in the text snippet.

In one embodiment, the semantic analysis described above includes at least one of the following items: word level semantic analysis, concept level semantic analysis, and semantic analysis based on ontologically similar concepts in text snippets.

In one embodiment, the first document and the second document are documents describing laws and regulations of a same domain in two respective regions.

By the above methods and apparatuses, topic models may be trained and obtained that better reflect the semantic correlation between topics and entities. By using such topic models, it is possible to determine the same topic in different documents, and then make semantic analysis on the text snippets under the same topic, realizing the effective comparison of the essential contents in documents.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
extracting, by one or more computer processors, a focused concept from a text snippet of a corpus document;
constructing, by one or more computer processors, one or more feature vectors for the focused concept, wherein each feature vector includes associative information that describes an ontology that includes the focused concept;
training a topic model, by one or more computer processors, based, at least in part, on at least one of the one or more feature vectors;
responsive to extracting, by one or more computer processors, a first topic set from a first document and a second topic set from a second document, matching, by one or more computer processors, one or more topics from the first topic set with one or more topics from the second topic set, using the topic model, to construct a matched topic set; and
responsive to performing, by one or more computer processors, a first semantic analysis on a first text snippet set of the first document and a second semantic analysis on a second text snippet set of the second document, wherein the first and the second text snippet sets are chosen based, at least in part, on the matched topic set, matching, by one or more computer processors, one or more text snippets of the first text snippet set with one or more text snippets of the second text snippet set based, at least in part, on the first and the second semantic analyses.

2. The method of claim 1, further comprising:
mapping, by one or more computer processors, the focused concept onto an ontology tree; and
obtaining, by one or more computer processors, the associative information based, at least in part, on information in the ontology tree.

3. The method of claim 2, wherein the associative information includes categorical information that describes the focused concept, and wherein the categorical information includes at least one of a super-category concept, a sub-category concept, and a concept that is equivalent to the focused concept.

4. The method of claim 2, wherein the associative information includes at least one of domain information that describes the focused concept and attributes of an entity that the focused concept describes.

5. The method of claim 1, wherein each of the one or more feature vectors is constructed based, at least in part, on at least one feature element of the corpus document, and wherein the at least one feature element includes at least one of statistical collocation information that describes the focused concept and contextual information that describes the focused concept.

6. The method of claim 1, further comprising:
extracting, by one or more computer processors, a first topic from a text snippet of the first document based, at least in part, on a feature vector of the text snippet of the first document;
adding, by one or more computer processors, the first topic to the first topic set;
extracting, by one or more computer processors, a second topic from a text snippet of the second document based, at least in part, on a feature vector of the text snippet of the second document; and
adding, by one or more computer processors, the second topic to the second topic set.

7. The method of claim 1, wherein:
the first document describes laws and regulations of a first region;
the second document describes laws and regulations of a second region; and
the first document and the second document describe, at least in part, laws and regulations that include the focused concept.

8. A non-transitory computer program product comprising:
a computer readable storage medium and program instructions stored on the computer readable storage medium, the program instructions comprising:
program instructions to extract a focused concept from a text snippet of a corpus document;
program instructions to construct one or more feature vectors for the focused concept, wherein each feature vector includes associative information that describes an ontology that includes the focused concept;
program instructions to train a topic model based, at least in part, on at least one of the one or more feature vectors;
program instructions to, responsive to program instructions to extract a first topic set from a first document and a second topic set from a second document, match, using the topic model, one or more topics from the first topic set with one or more topics from the second topic set to construct a matched topic set; and
program instructions to, responsive to program instructions to perform a first semantic analysis on a first text snippet set of the first document and a second semantic analysis on a second text snippet set of the second document, wherein the first and the second text snippet sets are chosen based, at least in part, on the matched topic set, match one or more text snippets of the first text snippet set with one or more text snippets of the second text snippet set based, at least in part, on the first and the second semantic analyses.

9. The computer program product of claim 8, the program instructions further comprising:
program instructions to map the focused concept onto an ontology tree; and
program instructions to obtain the associative information based, at least in part, on information in the ontology tree.

10. The computer program product of claim 9, wherein the associative information includes categorical information that describes the focused concept, and wherein the categorical information includes at least one of a super-category concept, a sub-category concept, and a concept that is equivalent to the focused concept.

11. The computer program product of claim 9, wherein the associative information includes at least one of domain information that describes the focused concept and attributes of an entity that the focused concept describes.

12. The computer program product of claim 8, wherein each of the one or more feature vectors is constructed based, at least in part, on at least one feature element of the corpus document, and wherein the at least one feature element includes at least one of statistical collocation information that describes the focused concept and contextual information that describes the focused concept.

13. The computer program product of claim 8, the program instructions further comprising:
program instructions to extract a first topic from a text snippet of the first document based, at least in part, on a feature vector of the text snippet of the first document;
program instructions to add the first topic to the first topic set;
program instruction to extract a second topic from a text snippet of the second document based, at least in part, on a feature vector of the text snippet of the first document; and
program instructions to add the second topic to the second topic set.

14. The computer program product of claim 8, wherein:
the first document describes laws and regulations of a first region;
the second document describes laws and regulations of a second region; and
the first document and the second document describe, at least in part laws and regulations that include the focused concept.

15. A computer system comprising:
one or more computer processors;
one or more computer readable storage media;
program instructions stored on the computer readable storage media for execution by at least one of the one or more processors, the program instructions comprising:
program instructions to extract a focused concept from a text snippet of a corpus document;
program instructions to construct one or more feature vectors for the focused concept, wherein each feature vector includes associative information that describes an ontology that includes the focused concept;
program instructions to train a topic model based, at least in part, on at least one of the one or more feature vectors;
program instructions to, responsive to program instructions to extract a first topic set from a first document and a second topic set from a second document, match, using the topic model, one or more topics from the first topic set with one or more topics from the second topic set to construct a matched topic set; and
program instructions to, responsive to program instructions to perform a first semantic analysis on a first text snippet set of the first document and a second semantic analysis on a second text snippet set of the second document, wherein the first and the second text snippet sets are chosen based, at least in part, on the matched topic set, match one or more text snippets of the first text snippet set with one or more text snippets of the second text snippet set based, at least in part, on the first and the second semantic analyses.

16. The computer system of claim 15, the program instructions further comprising:
program instructions to map the focused concept onto an ontology tree; and
program instructions to obtain the associative information based, at least in part, on information in the ontology tree.

17. The computer system of claim 16, wherein the associative information includes at least one of domain information that describes the focused concept and attributes of an entity that the focused concept describes.

18. The computer system of claim 15, the program instructions further comprising:
program instructions to extract a first topic from a text snippet of the first document based, at least in part, on a feature vector of the text snippet of the first document;
program instructions to add the first topic to the first topic set;
program instructions to extract a second topic from a text snippet of the second document based, at least in part, on a feature vector of the text snippet of the second document; and
program instructions to add the second topic to the second topic set.

19. The computer system of claim 15, wherein each of the one or more feature vectors is constructed based, at least in part, on at least one vector element of the corpus document, wherein the vector element is one of statistical collocation information that describes the focused concept and contextual information that describes the focused concept.

20. The computer system of claim 15, wherein:
the first document describes laws and regulations of a first region;
the second document describes laws and regulations of a second region; and
the first document and the second document describe, at least in part, laws and regulations that include the focused concept.
